(19) United States
(12) Patent Application Publication
(10) Pub. No.: US 2025/0108321 A1
(43) Pub. Date: Apr. 3, 2025

(54) STATIC STEAM LINE DRIER (SSLD) DEVICE

(71) Applicant: SAUDI ARABIAN OIL COMPANY, Dhahran (SA)

(72) Inventors: Ramis Arslanov, Dhahran (SA); Mishal Alsaiari, Abqaiq (SA)

(73) Assignee: SAUDI ARABIAN OIL COMPANY, Dhahran (SA)

(21) Appl. No.: 18/478,756

(22) Filed: Sep. 29, 2023

(51) Int. Cl. B01D 45/08; B01D 29/11; B01D 35/16; B01D 45/18

(52) U.S. Cl. CPC B01D 45/08; B01D 29/117; B01D 35/16; B01D 45/18

(57) ABSTRACT

A static steam line drier (SSLD) has a body, including a main flow path, a trap section proximate an upstream end of the SSLD body, and a constriction section proximate a downstream end of the SSLD body. The constriction section includes a seat around a constriction bore opening. A flow plug controller movably extends through a wall of the SSLD body, where the flow plug controller includes an external end located external to an outer surface of the SSLD body and a plug on an internal end located within the main flow path. The flow plug controller is oriented to allow the plug to be seated on the seat in the constriction section. The SSLD body also has a debris collector member extending from the trap section of the SSLD which includes a filter chamber and a blowdown valve provided at the collector member outlet.

### BACKGROUND

Steam is widely used as an energy transfer medium for driving equipment or heating substances. While distributing steam from a generation source, heat losses cause part of the steam to condense into liquid water, which may lead to an undesirable gas-liquid multiphase flow regime in a steam line system. Thermal heat loss in piping systems is a known phenomenon. Precise condensate water removal is crucial for steam line integrity and efficient steam line system operation. Failure to efficiently remove condensed water results either in the creation of shock waves or excessive steam losses, both of which affect the cost of steam generation. When the liquid water phase is not fully removed, thermal and dynamic shocks, also referred to as “steam hammering,” may result, leading to severe and permanent damage to the steam distribution network or even catastrophic failure. On the other hand, over displacement of water and steam will result in additional losses of demineralized water and heat energy, which may then require extensive remedial operation and an additional make-up water supply.

Steam trap failure is a prevalent industrial problem, leading to a steam trap service life of about 1 to 3 years, with high replacement cost. Prior art fixed nozzle-type steam trap devices control condensed liquids in steam lines by utilizing a nozzle or other means of constriction principle in the flow system. However, in conventional devices, these nozzles or constrictions are of fixed size and the bore opening cannot be adjusted without taking the device out of service in order to open and/or replace the orifice. Furthermore, conventional devices are expensive and relatively inflexible to the ability to change operating parameters.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a static steam line drier (SSLD) apparatus having an SSLD body, including a main flow path which extends through the SSLD body from an upstream end to a downstream end. The SSLD may include a trap section proximate the upstream end of the SSLD body, including a liquid catch plate extending radially inward from the SSLD body into the main flow path. Further, the SSLD may include a constriction section proximate the downstream end of the SSLD body, where a regulator plate may extend radially inward from the SSLD body into the main flow path, and where a radially inner end of the regulator plate forms a seat and defines a constriction bore opening through the constriction section and an intermediate section located between the trap section and the constriction section. A flow plug controller may movably extend through a wall of the SSLD body, where the flow plug controller includes an external end located external to an outer surface of the SSLD body, a plug on an internal end located within the main flow path, and a flow regulating handwheel provided on the external end of the flow plug controller. In addition, the SSLD body may have an integrally formed a debris collector member located in the trap section of the SSLD body. The debris collector member may include a filter chamber fluidly connected at one end with the main flow path and at an opposite end to a collector member outlet, at least one filter unit provided in the filter chamber, and a blowdown valve provided at the collector member outlet.

In another aspect, embodiments disclosed herein relate to a method for removing liquid condensate from a steam line system, including connecting an SSLD in line with a steam line system, where the SSLD includes a main flow path, a trap section containing a liquid catch plate, a constriction section containing a constriction bore opening, a flow plug controller extending through a wall of the SSLD body, and a debris collector member extending outwardly from the SSLD body in the trap section of the SSLD body. Methods for removing liquid condensate from a steam line system may include passing a fluid stream from an inlet located at the upstream side of the SSLD through the trap section, through the debris collector member, and into the constriction section. A position of the flow plug controller may be adjusted to alter the size of the constriction bore opening, where the size is equal to a distance between the flow plug controller and the radially inner end of the regulator plate. Methods may also include allowing the fluid stream to continue to pass axially through the constriction section of the SSLD body to an outlet located on the downstream side of the SSLD.

Other aspects and advantages of the claimed subject matter will be apparent from the following description and the appended claims.

### BRIEF DESCRIPTION OF DRAWINGS

FIG. 1 illustrates the main components of a static steam line drier (SSLD) in accordance with one or more embodiments.

FIG. 2 shows a cross-section view of a debris collector member portion of an SSLD in accordance with one or more embodiments.

FIG. 3A is a close-up view of a constriction section of an SSLD body, illustrating a maximum constriction bore size opening in accordance with one or more embodiments.

FIG. 3B is a close-up view of a constriction section of an SSLD body, illustrating a partial constriction bore size opening in accordance with one or more embodiments.

FIG. 3C is a close-up view of a constriction section of an SSLD body, illustrating a constriction bore size opening of zero in accordance with one or more embodiments.

FIG. 4A shows a steam line system with an SSLD according to one or more embodiments.

FIG. 4B shows a method for operating an SSLD during startup or normal operation according to one or more embodiments.

FIG. 4C shows a method for operating an SSLD during maintenance or a cleaning operation according to one or more embodiments.

FIG. 5 shows a cross-sectional view of an SSLD, taken along the longitudinal axis of the SSLD, according to embodiments of the present disclosure.

FIG. 6 shows a cross-sectional view of an SSLD, taken along a transverse plane transverse to the longitudinal axis of the SSLD, according to embodiments of the present disclosure.

### DETAILED DESCRIPTION

Embodiments disclosed herein generally relate to a Static Steam Line Drier (SSLD) device and methods of operation and use. The SSLD device may be made and operated without any moving parts that are entirely enclosed in the device, and thus, the device may be wear-free and require little maintenance. SSLD devices disclosed herein may be used to precisely remove liquid (e.g., water) from steam, henceforth minimizing the chance of thermal and dynamic shocks on steam distribution piping systems. SSLD devices disclosed herein may also eliminate excessive steam loss, which protects upstream and downstream lines from steam hammering. SSLD devices may perform several functions including filtering water condensate from mechanical debris, limiting steam losses, and fully draining water condensate from steam line systems. Additionally, SSLD devices are disclosed herein that may include mechanisms for controlling an internal variable orifice, to thereby change an internal bore size of the SSLD device, without the need to replace or reinstall a new nozzle.

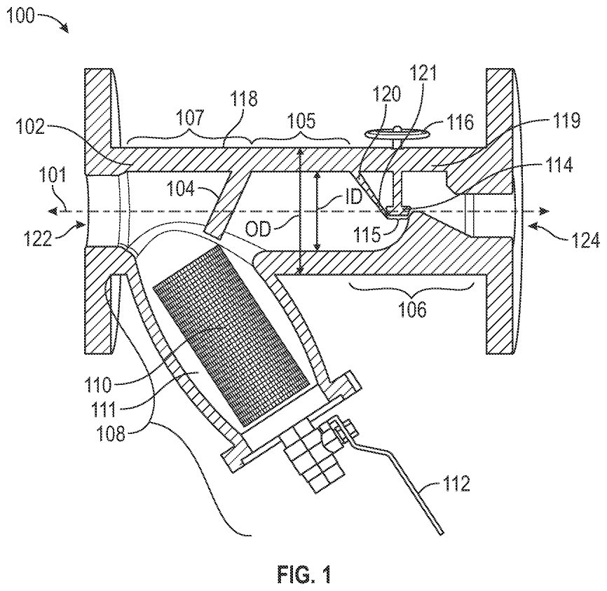

FIG. 1 illustrates an example of an SSLD 100 according to embodiments of the present disclosure. The SSLD 100 includes an SSLD body 102 having a main flow path formed axially therethrough, an upstream end 122, where a fluid stream may enter the main flow path during operation, and a downstream end 124 where the fluid stream may exit the main flow path during operation. In one or more embodiments, the upstream and downstream ends 122, 124 may be flanged for connection to other pipes in a steam flow system. The SSLD body 102 may be referred to in different sections of functionality and location, including, for example, a trap section 107, a constriction section 106, and an intermediate section 105 located axially between the trap section 107 and constriction section 106.

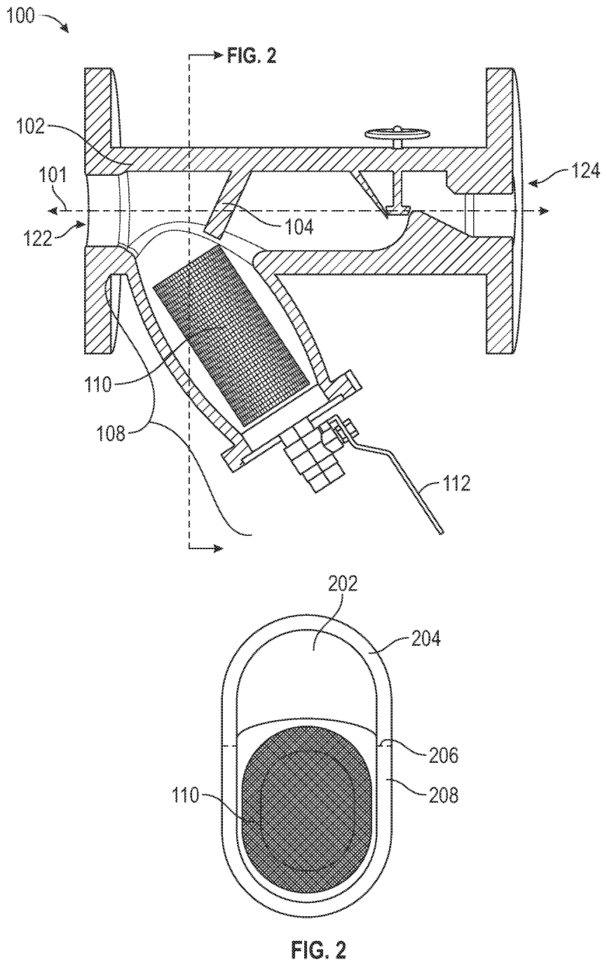

Additionally, the SSLD body 102 may have a generally tubular shape, extending axially along longitudinal axis 101, with an outer diameter (OD) defined by an outer surface 118. The main flow path through the SSLD body 102 has an inner diameter (ID) defined by an inner surface 119, which may vary axially throughout the SSLD body 102 around various components and through different sections in the SSLD body 102. For example, as shown in FIG. 1, the inner diameter of the SSLD body in the constriction section 106 may be less than the inner diameter in the intermediate section 105. As best shown in FIG. 2, a wall thickness 204 of the SSLD body 102 may be measured between the outer diameter and the inner diameter of the SSLD body 102.

In one or more embodiments, the SSLD body 102 is made of one or more metals. The metal used to make the SSLD body may include, for example, steel, stainless steel, brass, Inconel 625, and Incoloy 825. The SSLD body may be manufactured by any manufacturing method known in the art, including, but not limited to, casting and additive manufacturing (i.e., three-dimensional printing).

The trap section 107 of the SSLD body 102 may be located at or proximate to the upstream end 122 of the SSLD 100. The trap section contains a liquid catch plate 104 extending radially into the main flow path at an angle of between 0° and 90° relative to an inner surface 119 of the SSLD body 102 in a direction toward the upstream end 122 of the SSLD 102. In one or more embodiments, the liquid catch plate 104 is integrally formed into the SSLD body 102.

Additionally, a debris collector member 108 may extend radially outward from the SSLD body 102 in the trap section 107, where at least a portion of the debris collector member 108 is located along a shared transverse plane (a plane transverse to longitudinal axis 101) with the liquid catch plate 104. By positioning at least a portion of the debris collector member 108 along a shared transverse plane with the liquid catch plate 104, condensed liquid from a fluid flowing through the main flow path during operation may collect on the liquid catch plate 104 and travel down to collect in the debris collector member 108.

In one or more embodiments, the SSLD may be constructed without a debris collector member. For example, in steam system piping where the corrosion speed is very low (such as a steam distribution system made from stainless steel, galvanized, steel, and the like) and debris and/or dirt are not expected to form and collect in the SSLD the debris collector member may not be included. In such embodiments, an SSLD may include an inlet, a constriction section, and an outlet, where the main flow path through the SSLD may be substantially uniform along portions of the SSLD not forming the constriction section.

In the embodiment shown, the debris collector member 108 has a generally tubular-shaped body integrally formed to and extending from the SSLD body 102. In other embodiments, the debris collector member may be a separately formed body that is connected to the SSLD body. A filter chamber 111 is formed within the body of the debris collector member 108, where the filter chamber 111 is connected at one axial end to (and in fluid communication with) the main flow path in the trap section 107 of the SSLD body 102. A collector member outlet is provided at an opposite axial end of the filter chamber 111. At least one filter 110 is held within the filter chamber 111, where the filter 110 may be used to trap particles or debris flowing through the SSLD 100.

In one or more embodiments, the filter is a cylindrical-shaped module and may be any suitable filter type known in the art that is capable of trapping debris from a water stream. For example, the filter may be a solid, sponge-like body, constructed of a wire mesh, a metal mesh, a plastic fiber mesh, or the like. The filter may also be wire mesh, a metal mesh, or a plastic fiber mesh filter having a hollow/tubular structure. The filter may have a filtration degree in a range of from about 500 μm to about 800 μm. For example, the filter may have a filtration degree in a range having a lower limit of about 500, 550, and 600 μm to an upper limit of about 650, 700 and 800 μm, where any lower limit may be paired with any upper limit.

When the SSLD 100 is installed in a steam transfer system for use, the debris collector member 108 may be oriented in a gravitationally lower position relative to the liquid catch plate 104. In such orientation, the liquid catch plate 104 partially extends into the inner diameter of the SSLD body 102, radially downward toward the debris collector member 108, either perpendicular to the inner surface 119 or slanted toward the upstream end 122 of the SSLD 100. By slanting the liquid catch plate 104 toward the upstream end 122 (or perpendicularly with the inner surface 119) and downward toward the debris collector member 108, condensed liquid from a fluid flowing through the main flow path from the upstream end 122 may collect on the liquid catch plate 104 and travel down to the filter 110 in the debris collector member 108.

FIG. 2 shows a cross-section of the SSLD 100, oriented in an installed orientation, along a transverse plane (a plane extending transverse to the longitudinal axis 101) extending through the trap section 107 of the SSLD 100 at the fluid junction between the main flow path of the SSLD body 102 and the filter chamber 111 of the debris collector member 108. The cross-section is taken at an upstream location from and looking toward the liquid catch plate 104, such that an upstream surface 202 of the liquid catch plate 104 is shown, positioned gravitationally higher than the debris collector member 108. The upstream surface 202 of the liquid catch plate 104 is radially surrounded in part by the SSLD body wall 204, while the filter 110 is radially surrounded in full by the debris collector member wall 208. In the cross-sectional view of FIG. 2, a cross-section of the SSLD body wall 204 transitioning to the debris collector member wall 208 is shown at transition region 206. In one or more embodiments, the debris collector member 108 may be integrally formed to the SSLD body 102, where transition region 206 may be identified as the circumferential region around the fluid junction between the main flow path and the filter chamber 111 and through the SSLD wall thickness. In one or more embodiments, the debris collector member may be a separate piece which is welded to the SSLD body prior to operation, such that the transition region 206 makes up the weld line.

Referring again to FIG. 1, a blowdown valve 112 is positioned on an outlet cap that unscrews, at the collector member outlet, located coaxially downstream of the filter 110. The blowdown valve 112 may be used to selectively open/close access to the filter chamber 111. For example, when the filter 110 needs to be cleaned, the blowdown valve 112 may be quick-opened by a 90° rotation, which opens access through the collector member outlet and allows evacuation of any fluids and/or mechanical debris in the debris collector member 108 (e.g., trapped in the filter 110) by a steam line pressure purge. The filter 110 may be removed from the SSLD 100 by unscrewing the outlet cap and then unscrewing a threaded end of the filter from the SSLD (e.g., unscrewing a male end of the filter having a national pipe taper (NPT) threaded connection), for example for cleaning or replacement.

According to embodiments of the present disclosure, the constriction section 106 of the SSLD 100 may have an inner diameter which is smaller than the inner diameters in the trap and intermediate sections 107, 105 of the SSLD 100. The constriction section 106 may include a regulator plate 120 and/or a reduced inner diameter portion formed by a change in SSLD wall thickness (e.g., by an integrally formed regulator plate portion, as shown in FIG. 1) to form a constriction bore opening 115. The constriction bore opening 115 has a diameter less than the inner diameter of the SSLD body. The regulator plate 120, which may be integrally formed into the SSLD body 102, may extend radially inward at an angle of between 0° and 90° relative to an inner surface 119 of the SSLD body 102.

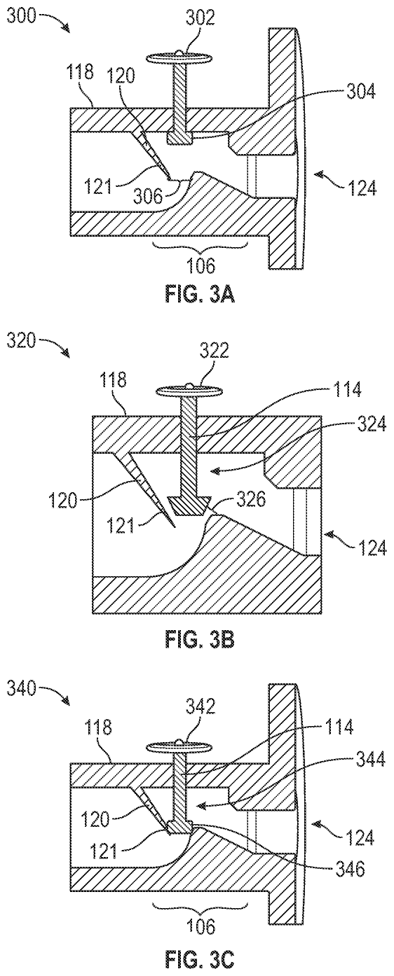

The SSLD 100 also includes a flow plug controller 114, having a stem connected at an axial end to a plug (as will be described in more detail in FIGS. 3A-C), which movably extends through the SSLD body 102 to provide different internal bore sizes within the constriction section 106 of the SSLD body 102. For example, a flow plug controller may extend through a wall of an SSLD body in an orientation where an internal end of the flow plug controller is aligned along the direction of flow plug controller movement with a constriction bore opening formed in the SSLD. The flow plug controller may be moved back and forth through the wall of the SSLD body to move the internal end of the flow plug controller farther from or closer to the constriction bore opening, where adjusting the position of the flow plug controller may alter the size of the constriction bore opening, as measured between the flow plug controller and a seat formed around the constriction bore opening. In one or more embodiments, a seat for receiving a flow plug controller may be formed by a reduced inner diameter portion of the SSLD body in the constriction section (which may be an integrally formed regulator plate portion of the SSLD body). In some embodiments, a radially inner end of the regulator plate 120 forms a seat 121 for the flow plug controller 114, where the flow plug controller 114 may seal against the seat 121 when in a closed position (as will be described in further detail in FIGS. 3A-C).

The flow plug controller 114 may include an external end located external to an outer surface 118 of the SSLD body 102 and an internal end located within the main flow path through the SSLD body 102. In one or more embodiments, a plug having a shape/size configured to mate with the seat 121 may be connected to the internal end of the flow plug controller 114, or the internal end of the flow plug controller 114 may have a plug shape/size configured to mate with the seat 121 integrally provided at the internal end of the flow plug controller 114. The flow plug controller 114 may be oriented through the wall of the SSLD body 102 to radially align the internal end (e.g., a plug) of the flow plug controller 114 with the seat 121.

A flow regulating handwheel 116 is provided on the external end of the flow plug controller 114 and is configured to radially adjust the position of the internal end of the flow plug controller 114 relative to the constriction bore opening 115, to thereby adjust the constriction bore opening 115 size. For example, in one or more embodiments, the flow plug controller 114 may by threadedly extended through the SSLD body wall 204, where rotation of the flow regulating handwheel 116 in a screw-out direction correspondingly moves the internal end of the flow plug controller 114 in a radially outward direction, thereby opening or enlarging the constriction bore opening 115. Conversely, rotation of the flow regulating handwheel 116 in a screw-in direction correspondingly moves the internal end of the flow plug controller 114 in a radially inward direction, thereby closing or reducing the constriction bore opening 115. When the flow plug controller 114 is in an open or partially open position, a constriction bore opening is created as the distance between the flow plug controller 114 and the seat 121 of the regulator plate 120.

Referring now to FIGS. 3A-C, operation of the flow plug controller 114 to adjust the constriction bore opening 115 size in the constriction section 106 of the SSLD 100 is shown. The system 300 of FIG. 3A illustrates how the constriction section 106 of the SSLD 100 appears when the flow plug controller 114 is in a fully open position 304. As mentioned with respect to FIG. 1 above, the flow regulating handwheel 116 may be configured to rotate and adjust the radial position of the flow plug controller 114 through the SSLD body 102. When the flow regulating handwheel 116 is rotated to a fully open position 302 to adjust the flow plug controller into the fully open position 304, a maximum constriction bore opening 306 is created. The size of the maximum constriction bore opening 306 may be equal to the diameter of the seat 121 formed by the regulator plate 120. Thus, when the flow plug controller 114 is moved to a fully open position, the entire diameter of the seat 121 is open (unblocked by the flow plug controller), thereby providing the maximum constriction bore opening 306.

In general, the constriction bore opening 115 is variable in size by radially adjusting the position of the flow plug controller relative to the constriction bore opening 115 to completely close (block) the constriction bore opening (formed across the diameter of the seat), partially open the constriction bore opening, or completely open the constriction bore opening 115. In one or more embodiments, the radial position of the flow plug controller may be controlled using a flow regulating handwheel with a scale corresponding to steam capacity to allow for manual adjustment of the SSLD for a wide variety of pressure conditions and line diameters.

The system 320 of FIG. 3B illustrates how the constriction section 106 of the SSLD 100 appears when the flow plug controller 114 is in a partially open position 324. When the flow regulating handwheel (116 in FIG. 1) is rotated to a partially open position 322 to adjust the flow plug controller into the partially open position 324, a partial constriction bore opening 326 is created. The size of the partial constriction bore opening 326 is equal to the radial distance between the partially open flow plug controller 324 and the seat 121. The size of the partial constriction bore opening 326 has a value of greater than zero and less than the maximum constriction bore opening 306.

The system 340 of FIG. 3C illustrates how the constriction section 106 of the SSLD 100 appears when the flow plug controller 114 is in a closed position 344. When the flow regulating handwheel is rotated to a closed position 342 to adjust the flow plug controller into the closed position 344, the constriction bore opening size 346 is zero, where the internal end of the flow plug controller 344 seals the seat 121.

The SSLD of one or more embodiments may operate under any of the conditions as described in FIGS. 3A-3C, depending on desired conditions such as pressures and line diameters. In some embodiments, the flow plug controller is in a closed position when purging debris from the debris collection member.

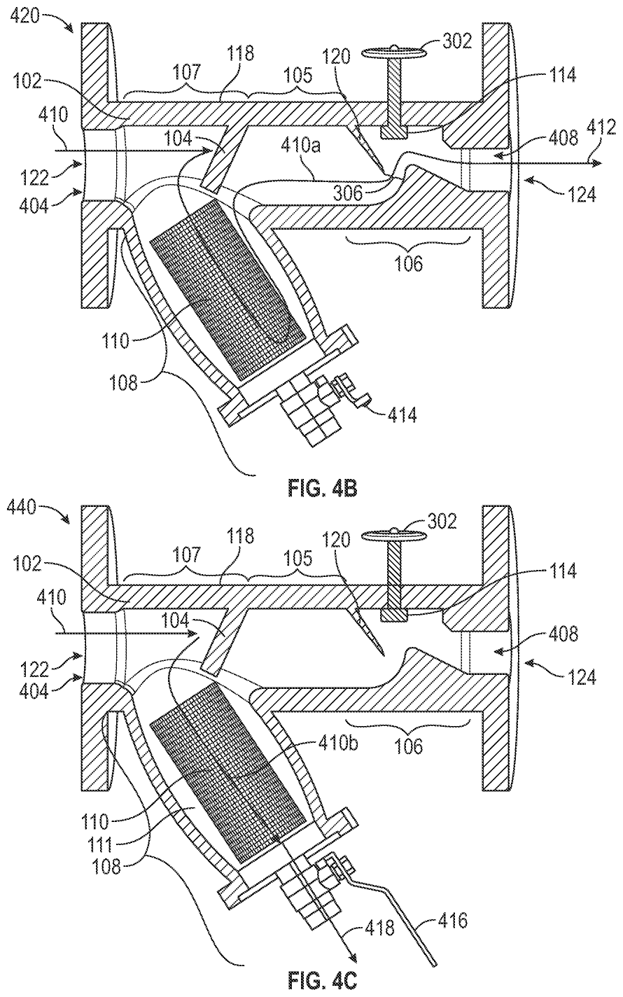

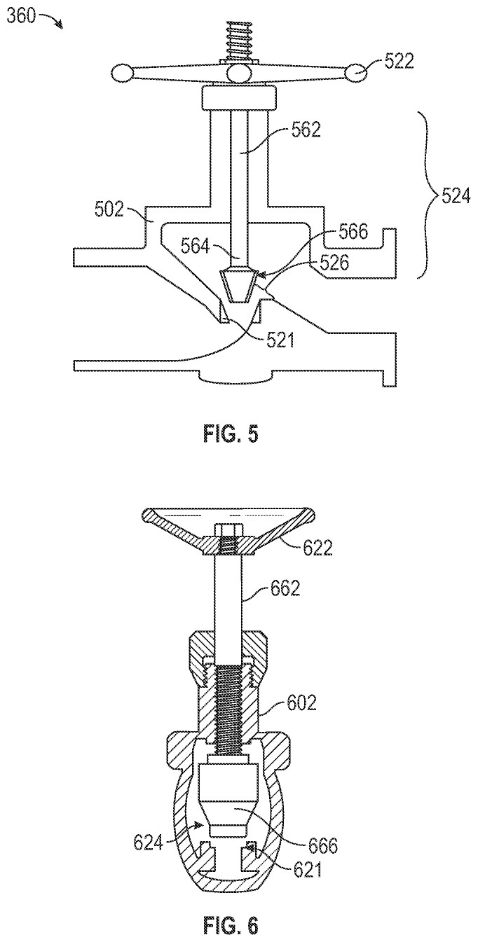

FIGS. 5 and 6 show additional examples of a flow plug controller operation in a constriction section of an SSLD. In FIG. 5, a sectional view of an SSLD according to one or more embodiments is shown, illustrating the components of a flow plug controller 524 in a partially open position. The flow plug controller 524 may extend through the SSLD body 502 in the constriction section of the SSLD. The flow plug controller 524 may have a stem 562 connected at a first axial end 564 to a plug 566. A second axial end of the stem 562 opposite the first axial end may be threadedly connected to a flow regulating handwheel 522, e.g., via a handwheel lock-nut. As shown in FIG. 5, when the flow regulating handwheel 522 is rotated to an open position, the plug 566 of the flow plug controller 524 may be spaced apart from a seat 521 formed in the constriction section of the SSLD body 502, where space between the plug 566 and seat 521 creates a partial constriction bore opening size 526, thereby providing a flow path through the constriction section of the SSLD. By rotating the flow regulating handwheel 522, the flow plug controller 524 may be moved in a closed direction such that plug 566 end of the flow plug controller 524 extends toward the seat 521 until the plug 566 meets the seat 521 and seals the flow path, thereby by creating a constriction bore opening size of zero (such as the condition shown and described in FIG. 3C).

In FIG. 6, a transverse sectional view of an SSLD according to embodiments of the present disclosure is shown, illustrating the components of a flow plug controller 624 in a partially open position. The flow plug controller 624 may extend through and be threaded to the SSLD body 602 in the constriction section of the SSLD. The flow plug controller 624 may have a stem 662 connected at a first axial end to a plug 666 and, at a second axial end opposite the first axial end, connected to a flow regulating handwheel 622. As shown in FIG. 6, when the flow regulating handwheel 622 is rotated to an open position, the plug 666 of the flow plug controller 624 may be spaced apart from a seat 621 formed in the constriction section of the SSLD body 602, where space between the plug 666 and seat 621 creates a partial constriction bore opening size, thereby providing a flow path through the constriction section of the SSLD.

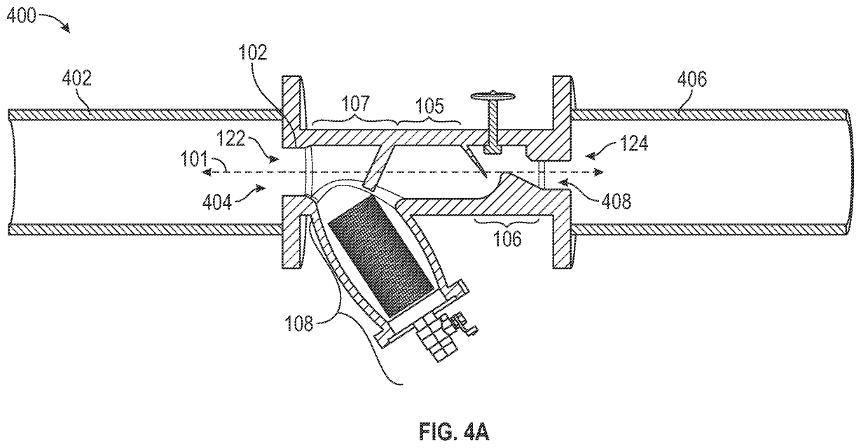

FIGS. 4A-C show a method for removing liquid condensate from a steam line system using an SSLD in accordance with one or more embodiments. In FIG. 4A, a generic system 400 is presented where an SSLD may be threaded to two parts of a steam line system. The SSLD may be connected to the steam line system at a gravitationally low point in the steam line system, such as a drip pocket or other piping elements where steam condensate is likely to occur. The SSLD includes a main flow path formed axially, along a longitudinal axis 101, therethrough from an inlet 404 at an upstream end 122 of the SSLD to an outlet 408 at a downstream end 124 of the SSLD. In some embodiments, the upstream end 122 may be connected to a first part of a steam line system 402 and the downstream end 124 may be connected to a second part of the steam line system 406 using flanged connections, thereby hermetically connecting the inlet 404 and outlet 408 to the flow paths formed through the first and second parts 402, 406 of the steam line system. In some embodiments, the upstream end 122 may be threaded to a first part of a steam line system 402, and the downstream end 124 may be threaded to a second part of the steam line system 406. In some embodiments, the second part of the steam line system 406 may be a condensate return system. In some embodiments, the outlet 408 may be vented to atmosphere.

FIG. 4B shows an SSLD 420 during startup or normal operation, according to one or more embodiments, where the blowdown valve is closed 414. In FIG. 4B, a fluid stream 410 flows from an upstream direction into the inlet 404 of the SSLD body 102. During startup, the fluid stream 410 may contain relatively cold, liquid water. As normal operation proceeds, the fluid stream 410 may contain a mixture of liquid water, and a gas or gases, including steam. During startup and normal operation, the fluid stream 410 passes through the inlet 404, to the trap section 107, and either through the filter 110 and down the debris collector member 108 as shown by fluid stream 410a, or the fluid stream 410 flows toward the upstream end of the liquid catch plate 104, where it is blocked from traveling further through the SSLD body 102. Fluid from the fluid stream 410 which is blocked by the liquid catch plate 104 is combined with fluid stream 410a and flows through the filter 110 and down the debris collector member 108. Because the blowdown valve is closed 414 during startup and normal operation, fluid stream 410a is forced to flow through the debris collector member 108 and into the intermediate section 105 of the SSLD body 102. While passing through the filter 110 in the debris collector member 108, dirt and debris are removed from the fluid stream 410a such that dirt and debris do not clog or block further downstream processes.

As the fluid stream 410a in FIG. 4B continues to travel through the intermediate section 105 in the downstream direction of the SSLD body 102, the fluid stream 410a may still be made up of all liquid, all gas, or a mixture thereof. However, in the SSLD 420, condensate may be continuously produced from fluid stream 410a, such that at least a small amount of condensate may be present in the intermediate section 105 of the SSLD body 102. Condensate formed in the intermediate section 105 may prevent gases (such as steam) in the fluid stream 410a from flowing into the constriction bore opening 306. Prevention of steam into the constriction bore opening 306 helps improve energy efficiency by reducing steam losses compared to other steam trap devices.

The constriction section 106 of the SSLD 420 may be used for a “pressure relief stage” because the constriction bore opening 306 diameter is smaller than the diameter of the SSLD body 102 outlet 408, leading to a pressure drop in the fluid stream 410a. The SSLD operates in accordance with the physics of a two-phase flow of a liquid at or near the liquid's boiling point. The pressure drop follows the pressure dependent boiling line for water, and excess energy is immediately converted to flash steam. Produced flash steam helps to regulate the amount of condensate which is able to pass through the constriction bore opening 306 as the pressure drop drives both steam and condensate in a downstream direction toward the constriction section 106. However, because water is denser than steam, condensate forms a water seal trap in the constriction section, thereby preventing steam from escaping the SSLD 420 at the downstream end 124. The pressure in the intermediate section 105 (upstream of the constriction section) is higher than the pressure in the constriction section 106, as determined by steam line pressure, while the pressure downstream of the constriction section 106 is near atmospheric. In addition, the pressure at the constriction bore opening 115 represents a low pressure of the system. Therefore, when condensate liquid encounters a lower pressure section, such as the constriction bore opening 115 within the constriction section 106, the condensate may partially re-evaporate and the generated flash steam chokes the constriction section 106, creating a variable local backpressure, which increases and decreases with as flow rate of condensate varies. The varying backpressure at the constriction section 106 allows the SSLD to self-regulate the condensate flow as the pressure and condensate load changes. Steam is thereby prevented from leaking through the SSLD 420 due to accumulation of condensate water seal at the inlet 404 to SSLD 420 while the condensate is preferentially discharged through the constriction.

As described with respect to FIGS. 3A and 3B, a flow regulating handwheel 302 may be used to position a flow plug controller into either a fully open position 304 (as shown, for example in FIG. 3A) or a partially open position 324 (as shown in FIG. 3B). Thus, adjusting the position of the flow plug controller 114 allows for the SSLD 420 to be used for various steam line pressures during operations and varying steam line diameters without having to open the SSLD 420 and interchange or replace parts. After flowing downstream of the constriction section 106, the fluid stream 410a partially recovers its pressure (represented as depressurized fluid stream 412 in FIG. 4B), and fluid stream 412 flows out of the outlet 408 of the SSLD body 102 where it may be vented to atmosphere or sent to a condensate return system, for example.

FIG. 4C shows an SSLD 440 in maintenance or cleaning operation, according to one or more embodiments, where the blowdown valve is open 416. In FIG. 4C, a fluid stream 410 flows from an upstream direction into the inlet 404 of the SSLD body 102. During maintenance or cleaning operation, the fluid stream 410 passes through the inlet 404 to the trap section 107 of the SSLD and through the filter 110 in the debris collector member 108, as shown by fluid stream 410b. Because the blowdown valve is open 416 during maintenance or cleaning, the fluid stream 410b may exit through the open blowdown valve, such that a resulting filtered fluid stream 418 is purged through the opening of the blowdown valve 416. When the fluid is fully purged, the debris collector member 108 may be opened in order to access the filter chamber 111 such that the filter 110 may be cleaned, maintained, or replaced.

An SSLD according to embodiments disclosed herein removes the determined liquid condensate rate from steam lines and prevents both thermal, flow induced, and hydraulic shocks leading to a service life which is up to three times longer than commercially available analogues. Because of well-known issues of current devices, such as steam hammering, the SSLD has potential for wide adaptation in industrial applications. The SSLD is applicable for any processing facility or steam distribution network.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A static steam line drier (SSLD), comprising:
an SSLD body comprising:
a main flow path extending through the SSLD body from an upstream end of the SSLD body to a downstream end of the SSLD body;
a trap section proximate the upstream end of the SSLD body, the trap section comprising:
a liquid catch plate extending radially inward from the SSLD body into the main flow path;
a constriction section proximate the downstream end of the SSLD body, the constriction section comprising:
a regulator plate extending radially inward from the SSLD body into the main flow path, wherein a radially inner end of the regulator plate forms a seat and defines a constriction bore opening; and
a flow plug controller extending through a wall of the SSLD body, the flow plug controller comprising:
an external end located external to an outer surface of the SSLD body;
an internal end located within the main flow path; and
a flow regulating handwheel provided on the external end of the flow plug controller; and
an intermediate section, located between the trap section and the constriction section; and
a debris collector member, extending from the trap section of the SSLD body, the debris collector member comprising:
a filter chamber fluidly connected at one end with the main flow path and at an opposite end to a collector member outlet;
at least one filter provided in the filter chamber; and
a blowdown valve provided at the collector member outlet.

2. The SSLD of claim 1, wherein a wall thickness of the SSLD body is measured between an outer surface of the SSLD body and an inner surface of the SSLD body, wherein the inner surface defines an inner diameter of the main flow path and varies axially throughout the SSLD body.

3. The SSLD of claim 2, wherein the regulator plate is integrally formed into the SSLD body and extends at an angle of between 0° and 90° relative to the inner surface of the SSLD body on the downstream end.

4. The SSLD of claim 3, wherein the liquid catch plate is integrally formed into the SSLD body and extends at an angle of between 0° and 90° relative to an inner surface of the SSLD body on the upstream end.

5. The SSLD of claim 1, wherein a constriction bore opening size is measured as a radial distance between the internal end of the flow plug controller and the seat.

6. The SSLD of claim 5, wherein the flow regulating handwheel is configured to rotate and adjust a position of the flow plug controller, wherein
when the flow regulating handwheel is rotated to adjust the flow plug controller into a closed position, the constriction bore opening size is zero,
when the flow regulating handwheel is rotated to adjust the flow plug controller into an open position, the constriction bore opening size is equal to a radial distance between the internal end of the flow plug controller and the seat, and
when the flow regulating handwheel is rotated to adjust the flow plug controller into a partially open position, the constriction bore opening size has a value of greater than zero.

7. The SSLD of claim 1, wherein the flow plug controller comprises a plug on the internal end, and wherein the flow plug controller is oriented through the wall of the SSLD body to radially align the plug with the seat.

8. The SSLD of claim 1, wherein the flow plug controller is threaded through the wall of the SSLD body.

9. The SSLD of claim 1, wherein the constriction bore opening has a diameter which is smaller than an inner diameter of the main flow path at the intermediate section of the SSLD body.

10. The SSLD of claim 1, wherein the at least one filter comprises wire mesh, metal mesh, plastic fiber mesh, or combinations thereof.

11. The SSLD of claim 1, wherein the debris collector member is integrally formed with the SSLD body.

12. A method for removing liquid condensate from a steam line system, comprising:
connecting an SSLD in line with a steam line system, wherein the SSLD comprises;
a main flow path extending through an SSLD body from an upstream end of the SSLD body to a downstream end of the SSLD body,
a trap section proximate the upstream end of the SSLD body, the trap section comprising:
a liquid catch plate extending radially inward from the SSLD body into the main flow path;
a constriction section proximate the downstream end of the SSLD body, the constriction section comprising:
a constriction bore opening defined between a seat and provided through the main flow path;
a flow plug controller extending through a wall of the SSLD body, the flow plug controller comprising:
an external end located external to an outer surface of the SSLD body; and
an internal end located within the main flow path;
an intermediate section, located between the trap section and the constriction section; and
a debris collector member, extending outwardly from the trap section of the SSLD body;
passing a fluid stream from an inlet located at the upstream end of the SSLD through the trap section, through the debris collector member, to the intermediate section, and into the constriction section;
adjusting a position of the flow plug controller to alter a size of the constriction bore opening, wherein the size is equal to a distance between the flow plug controller and the seat of the constriction bore opening; and
allowing the fluid stream to continue to pass axially through the constriction section of the SSLD body to an outlet located on the downstream end of the SSLD.

13. The method of claim 12, wherein the flow plug controller is threaded through the wall of the SSLD body.

14. The method of claim 12, wherein the flow plug controller comprises a flow regulating handwheel provided on the external end, and wherein adjusting the position of the flow plug controller comprises rotating the flow regulating handwheel.

15. The method of claim 12, further comprising adjusting the flow plug controller to a closed position to alter the size of the constriction bore opening to zero, wherein in the closed position, a plug on the internal end of the flow plug controller seals the constriction bore opening to prevent the fluid stream from flowing through the outlet.

16. The method of claim 12, wherein the flow plug controller is adjusted to a fully open position to alter the size of the constriction bore opening to a maximum size.

17. The method of claim 12, wherein the constriction bore opening has a diameter which is smaller than a diameter at the intermediate section of the SSLD body, such that a pressure drop in the fluid stream is created when the fluid stream passes from the intermediate section to the constriction section.

18. The method of claim 17, wherein a regulator plate portion integrally formed with the SSLD body extends inwardly into the main flow path in the constriction section of the SSLD to define the constriction bore opening, wherein the seat is formed at a radially inner end of the regulator plate portion.

19. The method of claim 12, wherein the debris collector member comprises:
a filter chamber fluidly connected at one end with the main flow path and at an opposite end to a collector member outlet;
at least one filter provided in the filter chamber; and
a blowdown valve provided at the collector member outlet.

20. The method of claim 19, further comprising:
opening the blowdown valve;
passing a fluid stream from the inlet of the SSLD through the at least one filter in the debris collector member to produce a filtered fluid stream; and
purging, through the blowdown valve, the filtered fluid stream.
